(19) United States
(12) Patent Application Publication
(10) Pub. No.: US 2013/0333230 A1
(43) Pub. Date: Dec. 19, 2013

(54) UTILITY KNIFE APPARATUS WITH BLADES HAVING MULTIPLE CUTTING EDGES

(71) Applicants: Elwood Dean Quimby, Derby, KS (US); Hubert J. Bung, Wichita, KS (US); Jeremy E. Weinman, Derby, KS (US)

(72) Inventors: Elwood Dean Quimby, Derby, KS (US); Hubert J. Bung, Wichita, KS (US); Jeremy E. Weinman, Derby, KS (US)

(21) Appl. No.: 13/971,633

(22) Filed: Aug. 20, 2013

Related U.S. Application Data
(63) Continuation-in-part of application No. 13/199,206, filed on Aug. 23, 2011.
(60) Provisional application No. 61/742,836, filed on Aug. 20, 2012.
(60) Provisional application No. 61/402,536, filed on Sep. 1, 2010.

(51) Int. Cl. B26B 5/00

(52) U.S. Cl. CPC B26B 5/00
USPC 30/321

(57) ABSTRACT

A utility knife employing a blade having multiple cutting edges, and a means for quickly and simply swapping out one cutting edge for another. In a preferred embodiment, a six-cutting-edge featured blade is employed. Each point of the six-cutting-edge featured blade features two distinct cutting edges, for a total of six cutting edges located on a single blade. The blade can be rotated about a central axis to expose new cutting edges as old edges wear and dull. In another embodiment, a single-edged blade featuring two cutting faces is housed in a knife handle. The blade can be flipped when the first edge is dull or worn to expose a second cutting face. The handle may optionally include a storage space for storing additional blades.

### CROSS-REFERENCES TO RELATED APPLICATIONS

This application claims priority in U.S. Provisional Patent Application No. 61/742,836, filed Aug. 20, 2012, and is a continuation-in-part of and claims priority in U.S. patent application Ser. No. 13/199,206, filed Aug. 23, 2011, which claims priority in U.S. Provisional Patent Application No. 61/402,536, filed Sep. 1, 2010, all of which are incorporated herein by reference.

### BACKGROUND OF THE INVENTION

1. Field of the Invention

This application relates to utility knife blades, and more particularly, to unconventional utility knife blades with six defined individual cutting edges that allow the user to have available on one blade, six individual cutting edges that will be used with special designed utility knives.

2. Background and Description of the Related Art

Conventional disposable utility blades are well known in the art. These blades, along with their knives, have many industrial as well as home uses, such as for opening boxes, cutting cord or cutting wallboard. Typical utility blades are encased in a plastic or metal handle in either a fixed or retractable position. When in use, the blade is positioned to extend outwardly from the handle, exposing the cutting edge and one of the cutting points of the blade.

Utility knife blades come in a variety of shapes depending upon the intended use. A conventional utility blade has a generally trapezoidal shape that includes a back edge, a cutting edge and two side edges. The trapezoidal shaped blades have two cutting edges or tips formed at the intersections between the side edges and the cutting edge. These sharp points or tips enable a user to puncture through a material which is desired to be cut, such as sealing tape or the cardboard box. Once the object has been punctured and penetrated, the user can slice open the material by dragging the knife along the surface of the material allowing the cutting edge to cut through the material.

Existing prior art includes U.S. Pat. Nos.: 7,921,568; 5,557,852; 2,542,582; 4,592,113; 3,037,342; 5,636,845; and 4,745,653.

Although trapezoidal-shaped utility blades are widely used, they have only two usable cutting edges. They have the disadvantage that when the two edges get dull, the blade has to be replaced. The two-edged blade, therefore, requires more frequent replacement after the two cutting edges are worn out.

Break-off style blades with a multitude of cutting edges are not well suited for many applications and there is a greater safety or injury risk due to potential snap-off during usage when side loads are applied.

There is a need for an improved utility knife blade that overcomes one or more of the above-described drawbacks and/or disadvantages of conventional prior art utility knife blades.

### SUMMARY OF THE INVENTION

The present invention provides a utility knife employing a blade having multiple cutting edges, and a means for quickly and simply swapping out one cutting edge for another.

In a preferred embodiment, six-cutting-edge featured blade is employed. Each point of the generally triangular-shaped, six-cutting-edge featured blade features two distinct cutting edges, for a total of six cutting edges located on a single blade. The blade can be rotated about a central axis to expose new cutting edges as old edges wear and dull.

In another embodiment, a single-edged blade featuring two cutting faces is housed in a knife handle. The blade can be flipped when the first edge is dull or worn to expose a second cutting face. The handle may optionally include a storage space for storing additional blades.

Other aspects and advantages of the present invention will become more readily apparent in view of the following detailed description and accompanying drawings.

### BRIEF DESCRIPTION OF THE DRAWINGS

FIG. 1 is an exploded isometric view of an embodiment of the present invention featuring a blade having six cutting faces.

FIG. 2 is an isometric view of a blade holder element of said embodiment.

FIG. 3 is a front elevational view thereof.

FIG. 4 is a side elevational view thereof.

FIG. 5 is a top plan view thereof.

FIG. 6 is an isometric view of a locking pin button element of said embodiment.

FIG. 7 is a side elevational view thereof.

FIG. 8 is a rear elevational view thereof

FIG. 9 is a top plan view of a right hand half of a knife handle element of said embodiment.

FIG. 10 is a rear elevational view thereof

FIG. 11 is a side elevational view thereof.

FIG. 12 is an isometric view thereof.

FIG. 13 is a top plan view of a left hand half of a knife handle element of said embodiment.

FIG. 14 is a rear elevational view thereof

FIG. 15 is a side elevational view thereof.

FIG. 16 is an isometric view thereof.

FIG. 17A is a side elevational view of a knife embodying said invention.

FIG. 17B is a front elevational view thereof

FIG. 18A is an isometric view of a three-sided blade.

FIG. 18B is a front elevational view thereof

FIG. 18C is a rear elevational view thereof, showing the blade edges located on the front face in hidden lines.

FIG. 18D is an isometric view of a three-sided blade of an alternative configuration.

FIG. 18E is a front elevational view thereof.

FIG. 18F is a rear elevational view thereof

FIG. 18G is a side elevational view of a three-sided blade being fitted into a simplified knife handle and blade receiver head.

FIG. 18H is a second step in a series thereof.

FIG. 181 is a third step in a series thereof.

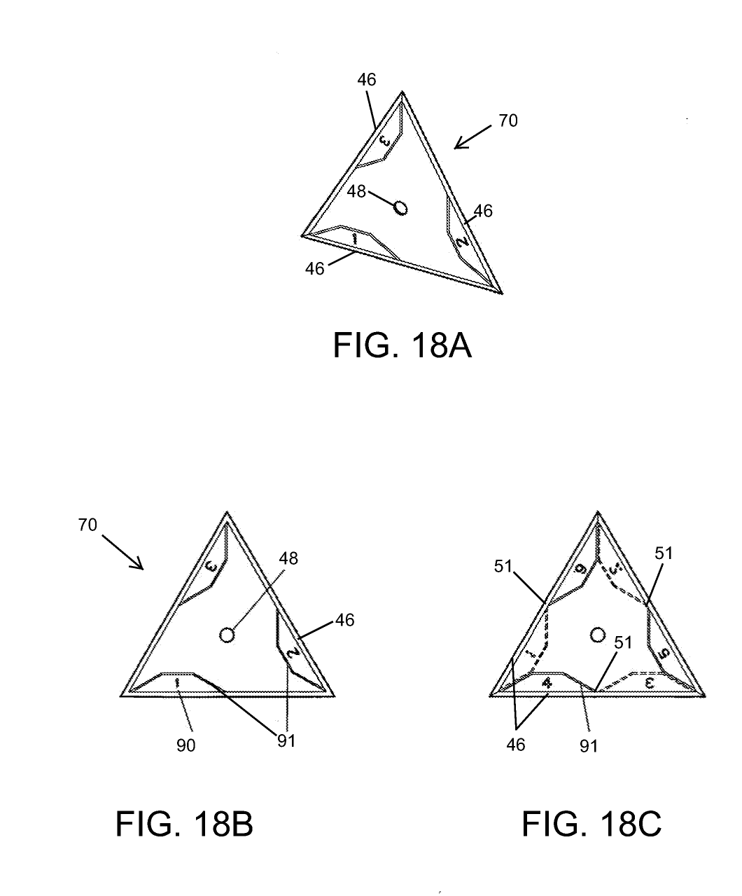

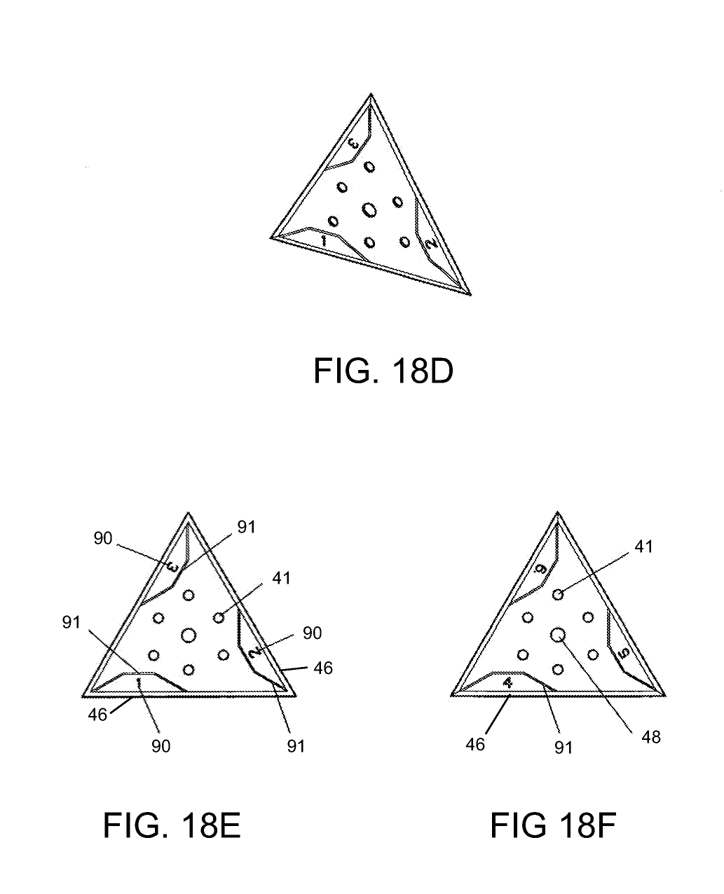

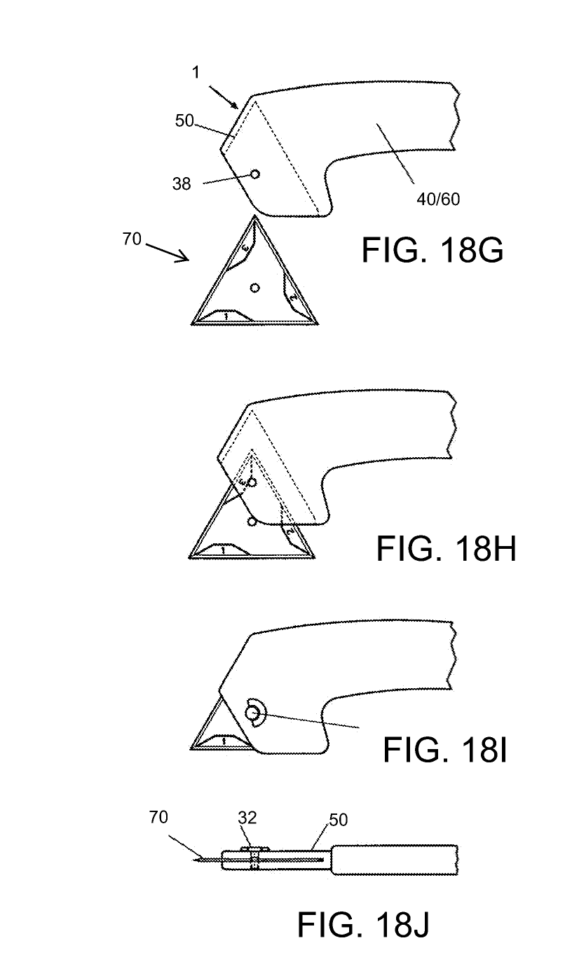

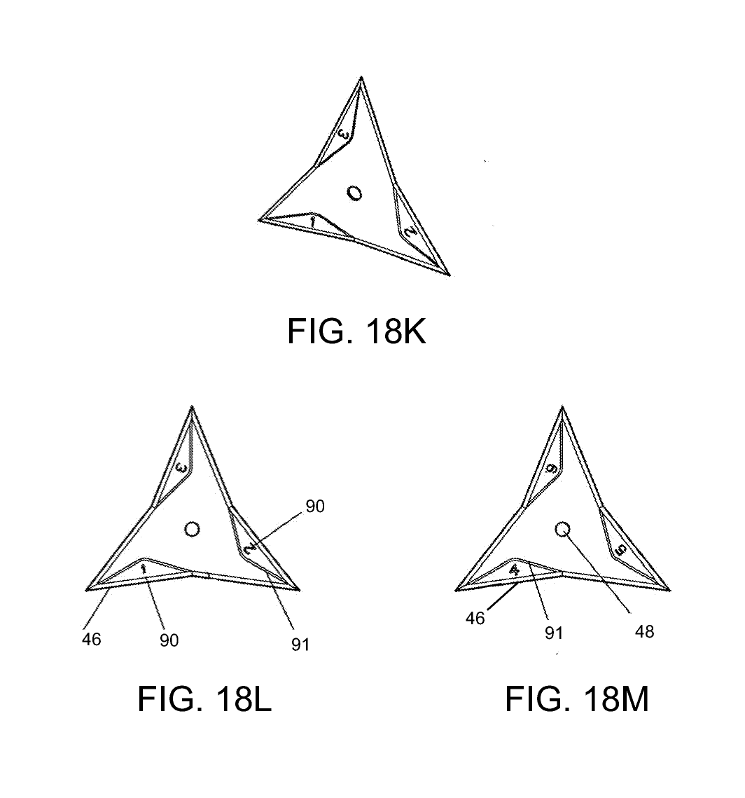

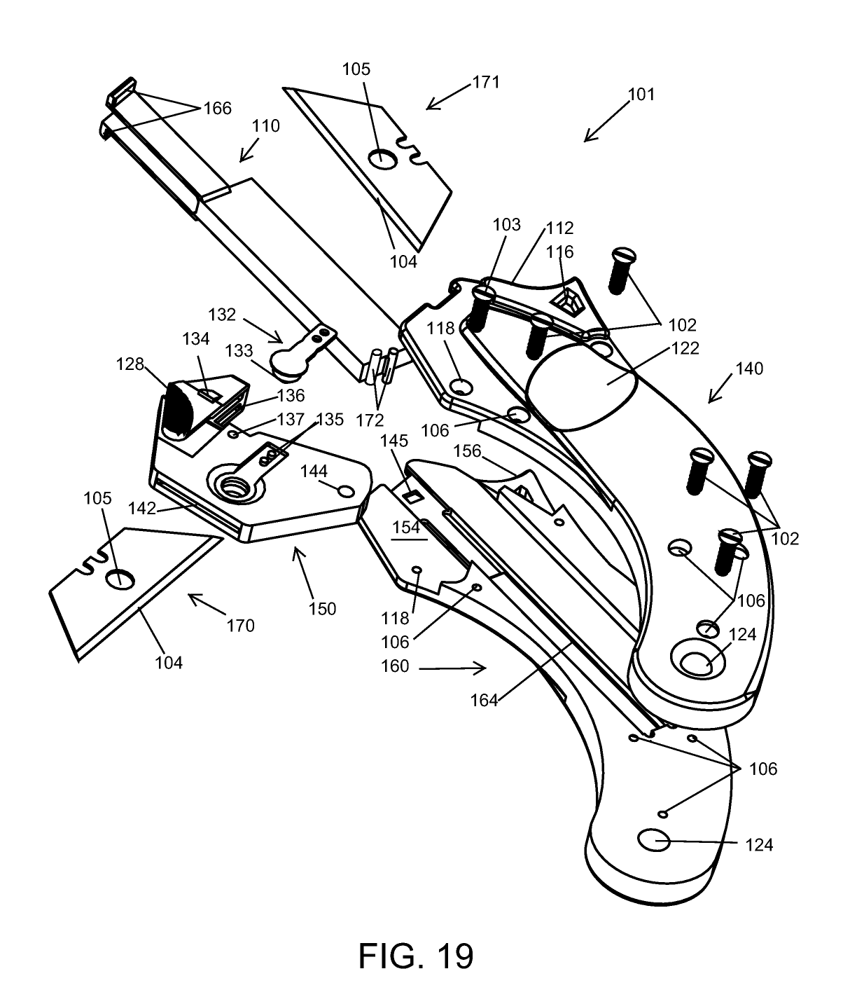

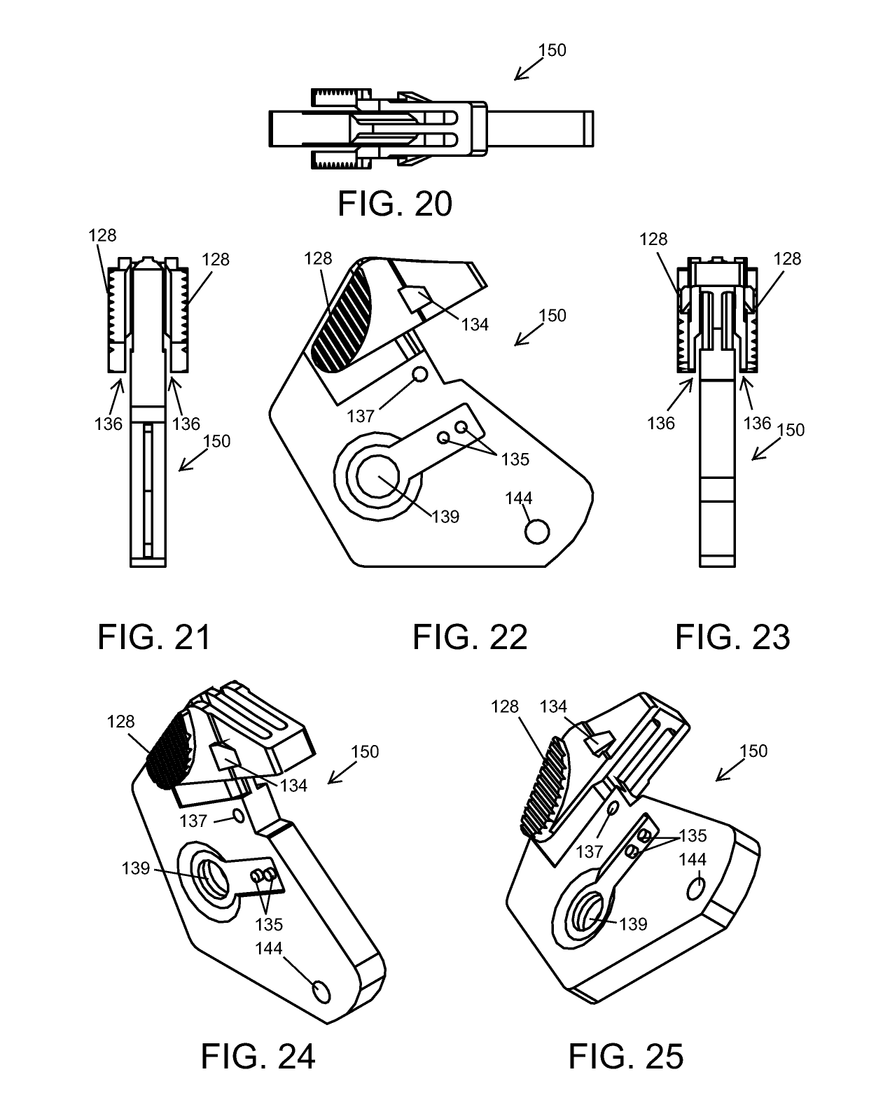

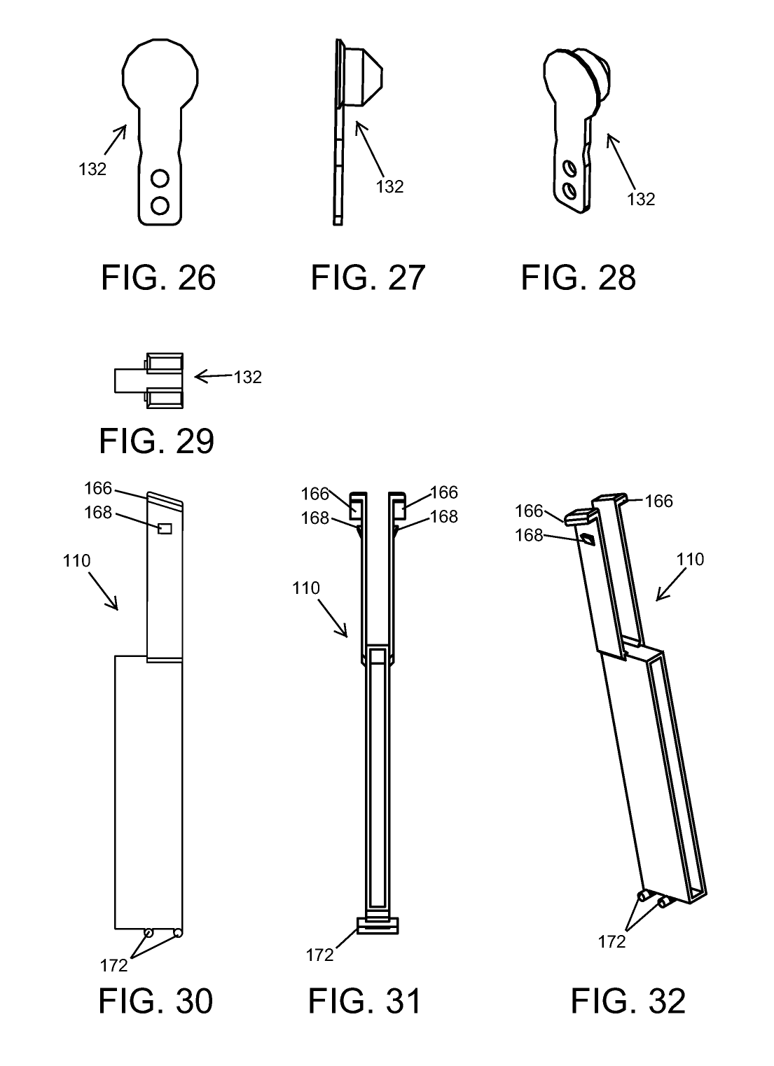

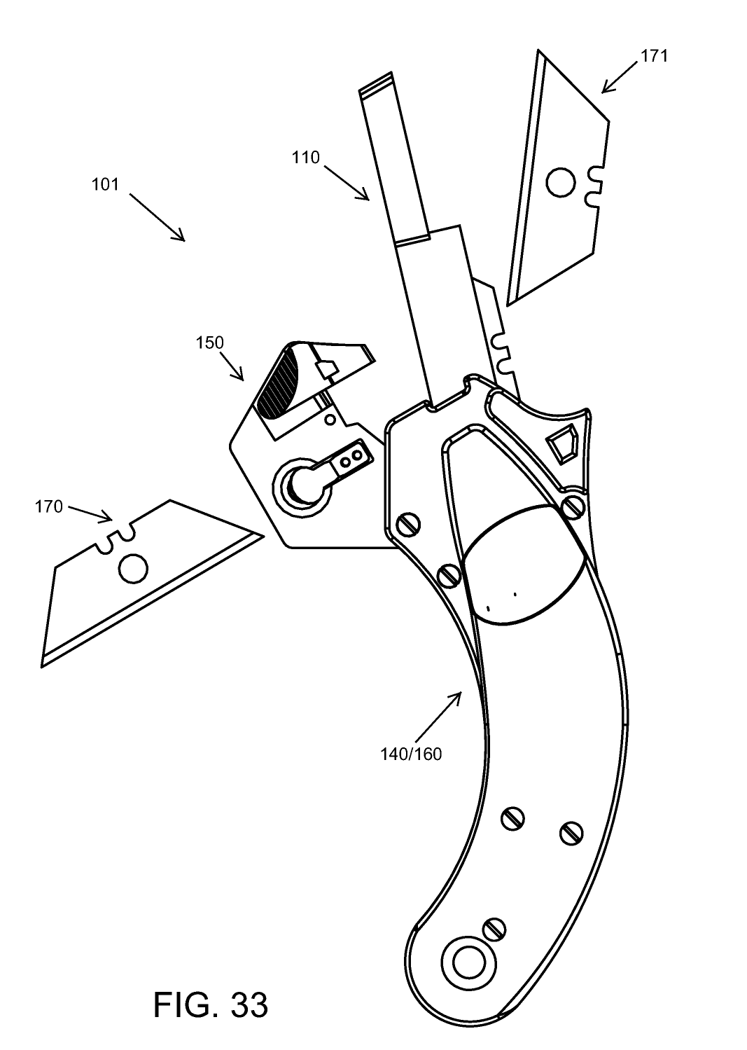

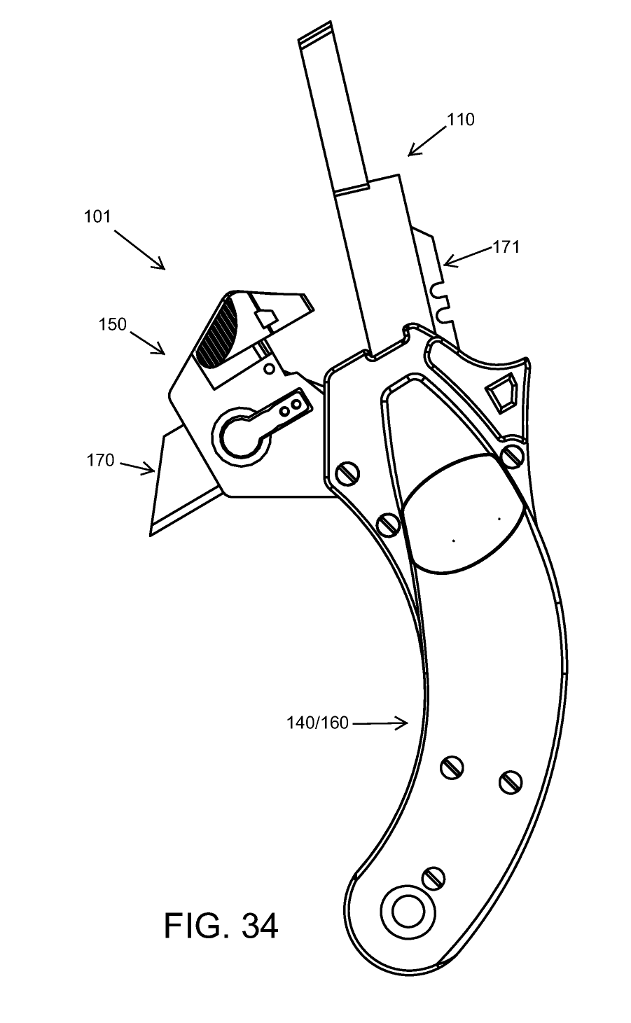

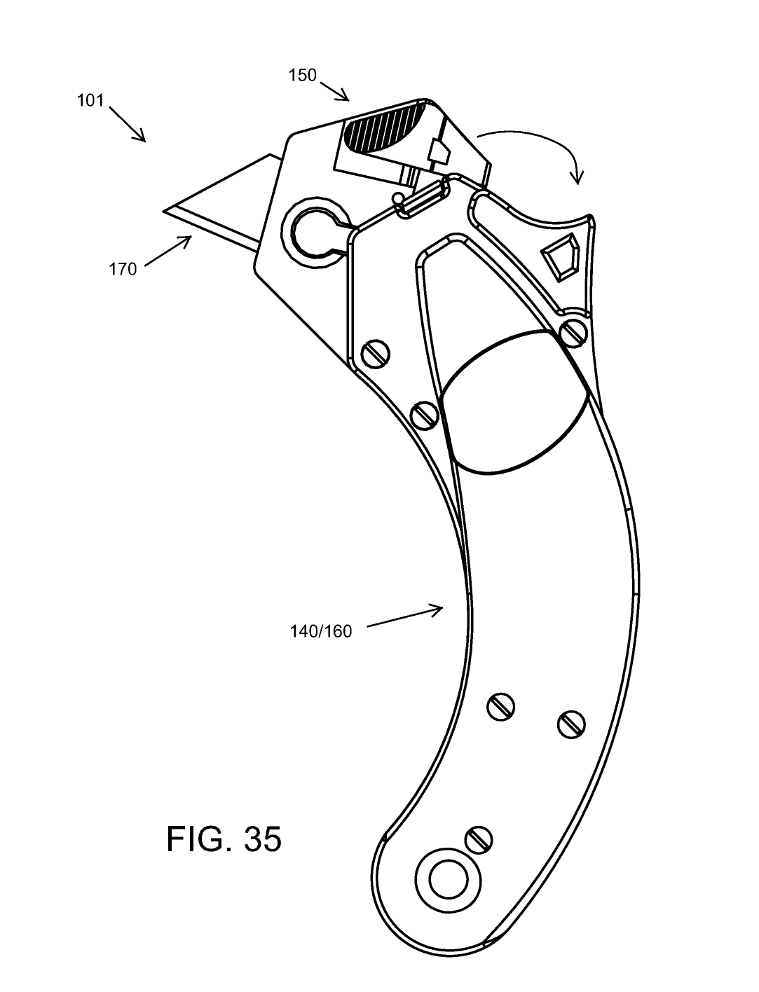

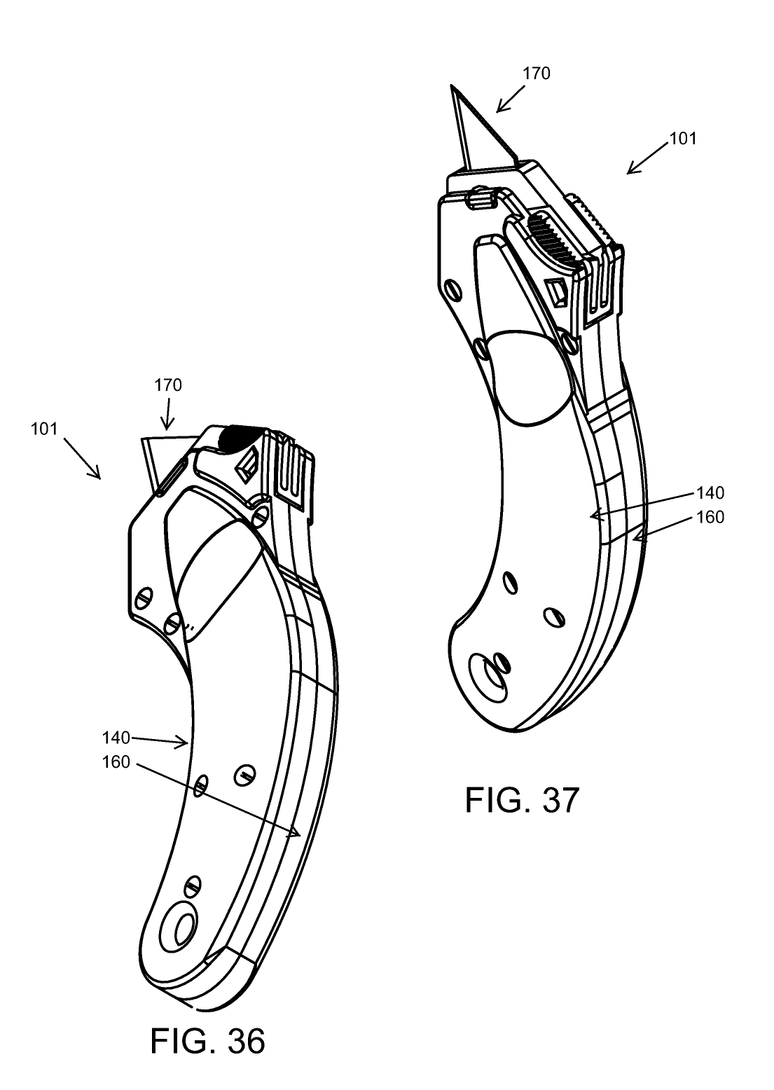

FIG. 18J is a top plan view thereof.

FIG. 18K is an isometric view of a three-sided blade of an alternative configuration.

FIG. 18L is a front elevational view thereof.

FIG. 18M is a rear elevational view thereof

FIG. 19 is an exploded isometric view of an alternative embodiment of the present invention featuring a single-edged blade having two cutting faces.

FIG. 20 is a top plan view of a blade holder element of said alternative embodiment.

FIG. 21 is a front elevational view thereof.

FIG. 22 is a side elevational view thereof.

FIG. 23 is a rear elevational view thereof

FIG. 24 is an isometric view thereof.

FIG. 25 is an alternative isometric view thereof.

FIG. 26 is a rear elevational view of a locking pin button element of said alternative embodiment.

FIG. 27 is a side elevational view thereof

FIG. 28 is an isometric view thereof.

FIG. 29 is a top plan view of a blade magazine clip element for said alternative embodiment.

FIG. 30 is a side elevational view thereof.

FIG. 31 is a front elevational view thereof.

FIG. 32 is an isometric view thereof.

FIG. 33 is a side elevational view of a knife embodying said alternative embodiment, shown in a disassembled position.

FIG. 34 is a side elevational view of a knife embodying said alternative embodiment, shown in partially assembled position having both a first blade and a second blade in position.

FIG. 35 is a side elevational view of a knife embodying said alternative embodiment, shown in an assembled position with the blade holder element rotating into position.

FIG. 36 is an isometric view of a knife embodying said alternative embodiment completely assembled.

FIG. 37 is an alternative isometric view thereof.

### DETAILED DESCRIPTION OF THE PREFERRED EMBODIMENTS

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, base, front, back, right and left refer to the invention as oriented in the view being referred to. The words “inwardly” and “outwardly” refer to directions toward and away from, respectively, the geometric center of the embodiment being described and designated parts thereof. Forwardly and rearwardly are generally in reference to the direction of travel, if appropriate. Said terminology will include the words specifically mentioned, derivatives thereof and words of similar meaning

A preferred embodiment features a knife blade body capable of allowing a knife blade to rotate or turn, thereby exposing additional cutting surfaces for use.

### II. Preferred Embodiment Utility Knife Apparatus 1

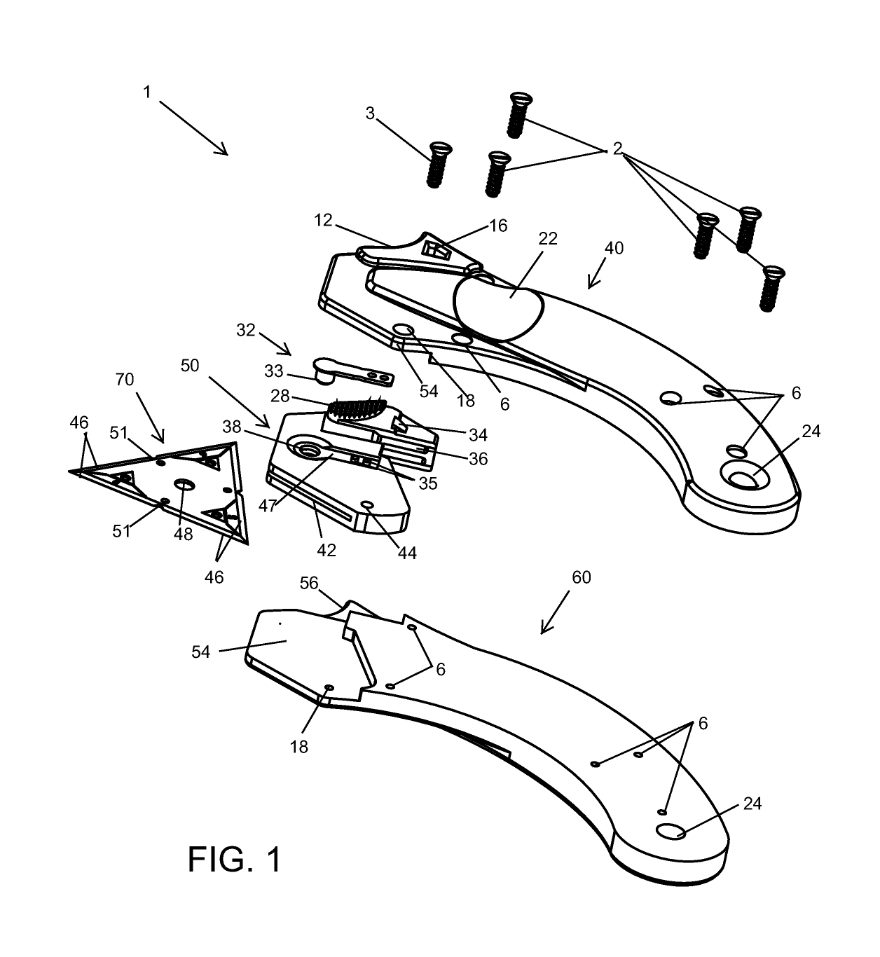

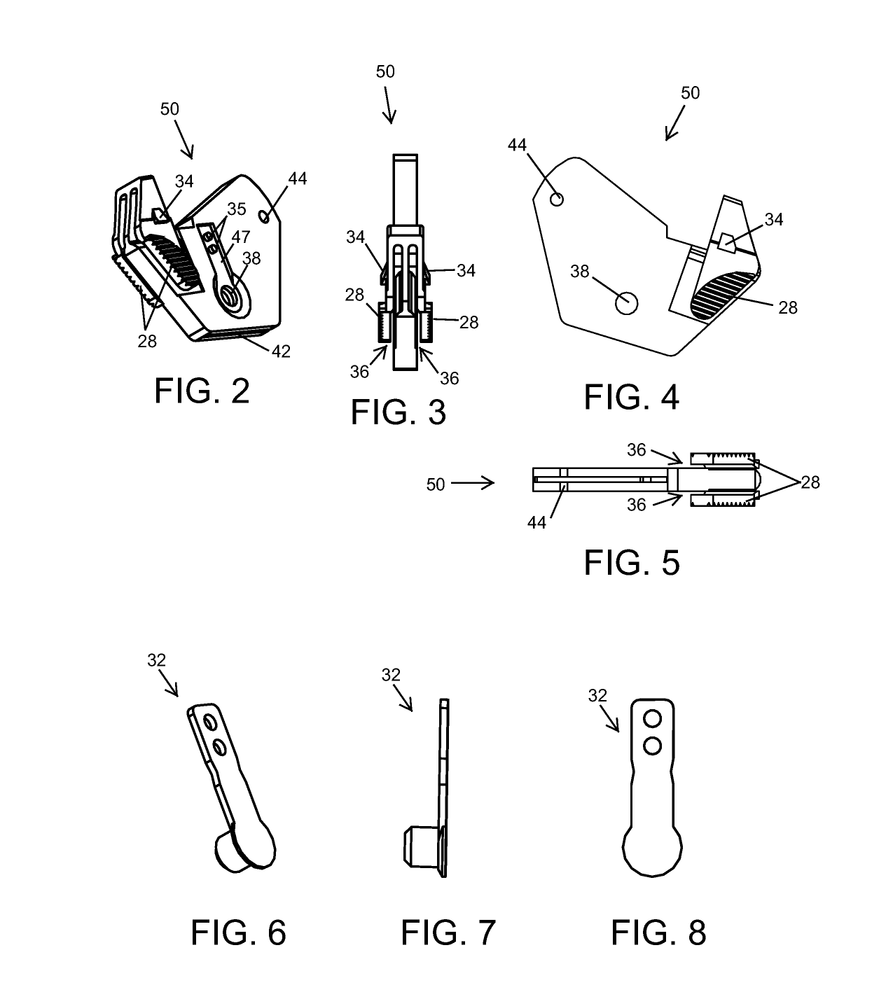

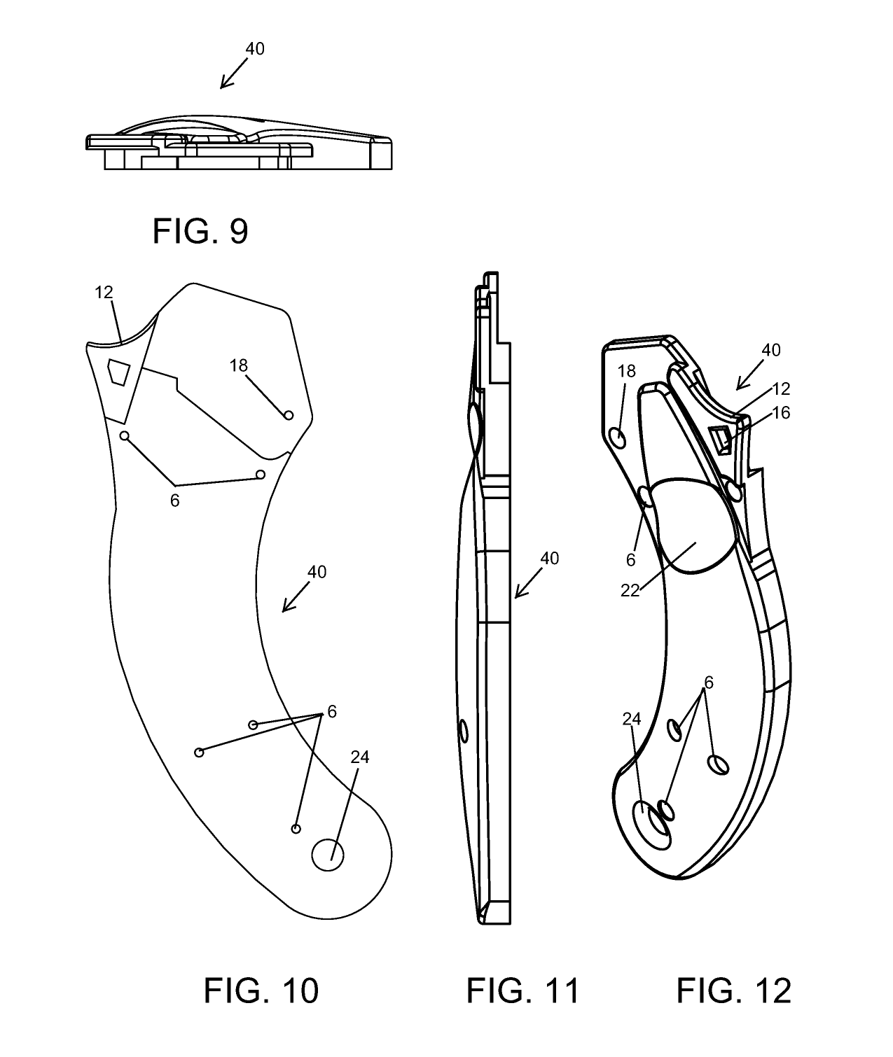

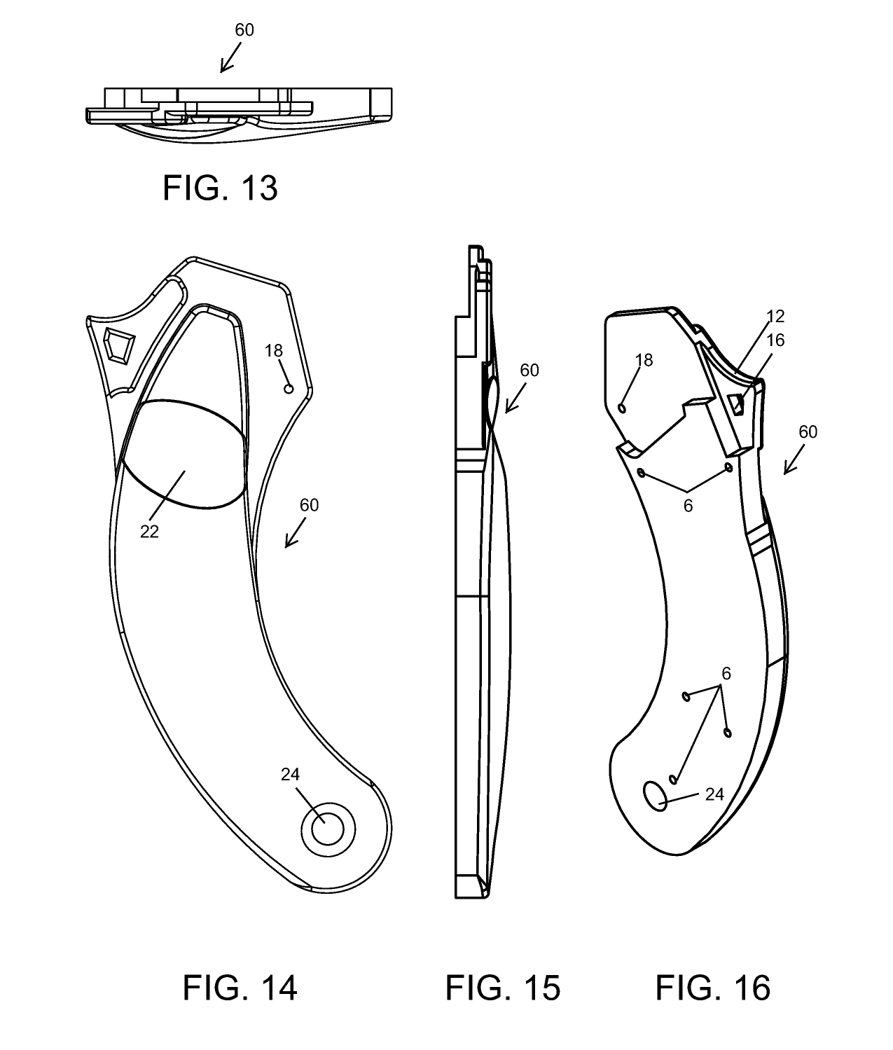

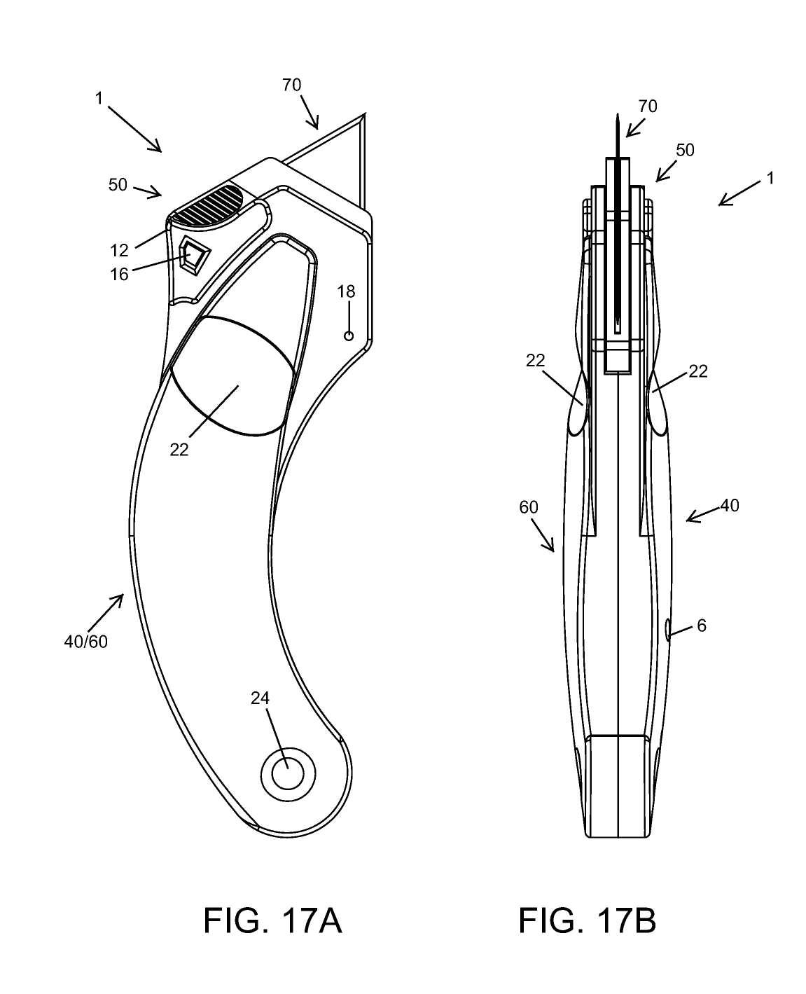

As shown in FIGS. 1-18, a preferred embodiment of the present invention includes a knife handle comprising a right portion 40 and a left portion 60, a six-cutting-edge featured knife blade 70, a blade receiving head 50 for holding the blade in place, and a locking button pin 32 for locking the blade 70 into the blade receiving head 50. A number of securing or mounting bolts 2 are used to join the various elements together, including joining the right handle portion 40 to the left handle portion 60 through a variety of mounting bolt holes 6. A pivot bolt 3 inserted through a pivot bolt hole 18 of the handle portions pivotally mounts the blade receiving head 50 to the handle.

Each handle portion 40, 60 includes a recess 22 for providing grip control when using the knife. A hook area 12 is located along the top edge of each handle portion, the hook area including a locking notch 16 which engages with the latching catch 34 located on the blade receiving head 50, thereby locking the head in place between the two handle portions. The handle portions also include a knife hanging hole 24 which would allow a string or other structure to be looped through the hole for easy storage or transport of the assembled knife 1. Each handle portion 40, 60 includes a recess 54 for receiving the blade receiving head 50, and a recess 56 for receiving the flexible finger grip 28 which allows for the release of the latching catch 34, which thereby allows the receiving head 50 to pivot about the pivot bolt 3.

The blade receiving head 50 also includes a pivot hole 44 for receiving the pivot bolt 3 after passing through the right handle portion 40 pivot hole 18. This pivotally engages the blade receiving head with the handle portions. The blade 70 is inserted into a blade slot 42 located in the blade receiving head 50. The locking button pin 32 locks the blade in place within a recess area 47 located on the blade receiving head by inserting the button 33 through the blade retaining hole 48 located in the blade, and the blade retaining hole 38 located in the opposite side of the blade retaining head 50. To switch which blade edge is active, the blade can be removed, flipped and turned, and reinserted to present a new blade. The locking button pin 32 is further secured in place to the blade receiving head by a pair of pegs 35 located on the top face of the blade receiving head.

The blade receiving head 50 also includes a flex area 36 which allows inward movement of a finger squeeze grip element 28 which ultimately releases the latch catch 34 from the knife handle portions 40, 60 when the knife is assembled, thereby allowing the head to rotate away from the handle such that the blade can be turned or flipped, thereby presenting a new cutting edge.

FIGS. 18A-18M provide more detail on how the three-sided blade plays a role in the preferred embodiment of the present invention. FIGS. 18A-C show how the knife blade previously described presents six cutting edges, and how each edge can be presented from the knife handle by flipping or turning the blade within the blade retaining head. Each cutting edge is labeled by an edge label 90. A blade cutting edge indicator 91 distinguishes the cutting edge from the body of the blade. FIG. 18C shows the gap 51 located between two separate cutting edges 46. The gap can be a flat space, a notch, or it could be a continuous cutting edge. The purpose of the gap 51 is to designate between two separate cutting edges. FIGS. 18D-F show an alternative arrangement of the three-sided blade which includes a secondary ring of mounting holes 41 which provides additional stability to a blade secured by those holes in addition to the blade retaining hole 48. FIGS. 18G-J show how the cutting edge labeled “1” is presented initially when the blade is received by the blade receiving head 50. FIGS. 18K-M provide even more options for how the cutting edges of the three-sided blade may be presented.

### III. Alternative Embodiment Utility Knife Apparatus 101

As shown in FIGS. 19-37, an alternative embodiment of the present invention includes a knife handle comprising a right portion 140 and a left portion 160, a knife blade 170 having a single cutting edge 104, a blade receiving head 150 for holding the blade in place, and a locking button pin 132 for locking the blade 170 into the blade receiving head 150. A number of securing or mounting bolts 102 are used to join the various elements together, including joining the right handle portion 140 to the left handle portion 160 through a variety of mounting bolt holes 106. A pivot bolt 103 inserted through a pivot bolt hole 118 of the handle portions pivotally mounts the blade receiving head 150 to the handle.

Each handle portion 140, 160 includes a recess 122 for providing grip control when using the knife. A hook area 112 is located along the top edge of each handle portion, the hook area including a locking notch 116 which engages with the latching catch 134 located on the blade receiving head 150, thereby locking the head in place between the two handle portions. The handle portions also include a knife hanging hole 124 which would allow a string or other structure to be looped through the hole for easy storage or transport of the assembled knife 101. Each handle portion 140, 160 includes a recess 154 for receiving the blade mounting head 150, and a recess 156 for receiving the flexible finger grip 128 which allows for the release of the latching catch 134, which thereby allows the receiving head 150 to pivot about the pivot bolt 103.

The blade receiving head 150 also includes a pivot hole 144 for receiving the pivot bolt 103 after passing through the right handle portion 140 pivot hole 118. This pivotally engages the blade receiving head with the handle portions. The blade 170 is inserted into a blade slot 142 located in the blade receiving head 150. The locking button pin 132 locks the blade in place by inserting the button 133 through the blade retaining hole 105 located in the blade, and the blade retaining hole 139 located in the opposite side of the blade retaining head 150. To switch which blade edge is active, the blade can be removed, flipped and turned, and reinserted to present a new blade. The locking button pin 132 is further secured in place to the blade receiving head by a pair of pegs 135 located on the top face of the blade receiving head. A blade positioning pin 137 ensures the blade is accurately lined up within the blade receiving head 150.

Similar to the previous embodiment, a hook area 112 is located along the top edge of each handle portion, the hook area including a locking notch 116 which engages with the latching catch 134 located on the blade receiving head 150, thereby locking the head in place between the two handle portions. The blade receiving head 150 also includes a flex area 136 which allows inward movement of a finger squeeze grip element 128 which ultimately releases the latching catch 134 from the knife handle portions 140, 160 when the knife is assembled, thereby allowing the head to rotate away from the handle such that the blade can be turned or flipped, thereby presenting a new cutting edge.

The alternative embodiment knife 101 also includes a magazine clip 110 for holding a spare blade 171 within the blade handle portions 140, 160. This element is shown in more detail in FIGS. 29-32. The clip 110 includes a pair of flex finger grips 166 for squeezing the two halves of the clip together, which releases the latch lock 168 from a latch lock receiver 145. When the magazine clip 110 is fully inserted into a slide and containment area 164 located internally within the knife case, the clip is held in place by the latch locks 168 seated in the latch lock receivers 145. The forward section of the magazine clip 110 flexes, allowing the finger grips 166 to be squeezed inwardly, thus releasing the latch locks 168. The clip can then be pulled from the knife which exposes spare blades 171 for replacing the original blade 170. The magazine clip further includes two movement control pins 172 which permits movement of the clip while the clip is stored within the handle, while ensuring that the clip remains within the handle. The control pins 172 do allow the magazine 110 to be withdrawn from the handle portions 140, 160 far enough to remove a replacement blade, but the magazine is not allowed to be completely removed. When rotating the blade retaining head 150 to the closed position as shown in FIG. 35, the magazine 110 automatically snaps into a locked position.

Note also that the blade 170 can be flipped to expose a second cutting face along the same single cutting edge 104.

It is to be understood that while certain aspects of the disclosed subject matter have been shown and described, the disclosed subject matter is not limited thereto and encompasses various other embodiments and aspects.

Having thus described the invention, what is claimed as new and desired to be secured by Letters Patent is:

1. A knife comprising:
a disposable blade having multiple cutting edges, a positioning pin receiving hole, and wherein each of said multiple cutting edges is separated by a gap;
a housing including a handle portion comprising a first half and a second half, wherein said first half is joined to said second half by a plurality of mounting bolts;
a head unit having a positioning pin receiving hole passing through its center, and a pivot bolt receiver hole passing through near an edge of said head unit;
said head unit further including a blade receiver slot adapted for receiving said disposable knife blade such that only one of said multiple cutting edges is employed;
a pivot bolt pivotally mounting said head unit to said housing between said first half and said second half;
a removable positioning pin locking said blade within said head unit via said blade positioning pin receiving hole and said head unit positioning pin receiving hole;
said head unit further including a grip button having a latch catch; and
said housing including a locking notch adapted for receiving said latch catch, thereby preventing rotation of said head unit about said pivot bolt.

2. The knife of claim 1, further comprising:
said blade having a planar body with three distinct points, each said point facing a direction 120 degrees from the other two respective points; and
said blade having three pairs of cutting edges, each pair of cutting edges culminating into one of said three distinct points.

3. The knife of claim 2, wherein each of said cutting edges is labeled with a number, said numbers increasing in sequential order from one to six.

4. The knife of claim 2, further comprising:
wherein one of thee said distinct points comprises an exposed point; and
wherein two of said three distinct points comprise a set of unexposed points.

5. The knife of claim 4, further comprising:
wherein the pair of cutting edges culminating in said exposed point further include an upper exposed edge and a lower exposed edge; and
wherein said lower exposed edge is engaged in a cutting motion.

6. The knife of claim 1, further comprising:
said blade having a planar body with two distinct points, each said point facing a direction 180 degrees from the other respective point; and
said blade having two cutting edges located along the same side of said blade, each said cutting edge culminating into one of said two points.

7. The knife of claim 6, further comprising:
a magazine clip having a rectangular lower body including a top wall, a bottom wall, two side walls, and a back wall, wherein said top, bottom, back, and sidewalls define a storage space having an opening;
said magazine clip further including a pair of upstanding arms each culminating in a grip, said arms being capable of flexing;
each said upstanding arm including a latch lock capable of engagement with said locking notch; and
at least one replacement blade contained within said storage space, said replacement blade having the same features as said blade.

8. The knife of claim 1, further comprising:
said head unit including a recessed space having a pair of pegs;
said positioning pin including a pair of peg receptacles; and
wherein said positioning pin is received within said recessed space and said peg receptacles are adapted to secure said positioning pin on said pair of pegs.

9. The knife of claim 1, wherein each of said first and second halves of said housing include a grip recess area.

10. The knife of claim 1, wherein each of said first and second halves of said housing include a hanging hole, said hanging hole of said first half aligned with said hanging hole of said second half, such that said hanging holes form an opening running through said housing.

11. A knife comprising:
a disposable blade having a planar body with a plurality of distinct points and a positioning pin receiving hole;
each of said distinct points including a pair of cutting edges, wherein one of the said distinct points comprises an exposed point, and wherein the remaining points comprise a set of unexposed points;
wherein each of said multiple cutting edges is separated by a gap;
wherein the pair of cutting edges culminating in said exposed point further include an upper exposed edge and a lower exposed edge, said lower exposed edge being engaged in a cutting motion;
a housing including a handle portion comprising a first half and a second half, wherein said first half is joined to said second half by a plurality of mounting bolts;
a head unit having a positioning pin receiving hole passing through its center, and a pivot bolt receiver hole passing through near an edge of said head unit;
said head unit further including a blade receiver slot adapted for receiving said disposable knife blade such that only one of said multiple cutting edges is employed;
a pivot bolt pivotally mounting said head unit to said housing between said first half and said second half;
a removable positioning pin locking said blade within said head unit via said blade positioning pin receiving hole and said head unit positioning pin receiving hole;
said head unit further including a grip button having a latch catch; and
said housing including a locking notch adapted for receiving said latch catch, thereby preventing rotation of said head unit about said pivot bolt.

12. The knife of claim 11, wherein each of said cutting edges is labeled with a number, said numbers increasing in sequential order.

13. The knife of claim 11, wherein said gap comprises a notch within said blade surface.

14. The knife of claim 11, wherein said gap comprises a flat space within said blade surface.

15. The knife of claim 11, wherein said gap comprises a continuous cutting edge.
